(19) United States
(12) Patent Application Publication
(10) Pub. No.: US 2014/0287912 A1
(43) Pub. Date: Sep. 25, 2014

(54) Process for Preparing a Monolithic Catalysis Element Comprising a Fibrous Support and Said Monolithic Catalysis Element

(71) Applicants: HERAKLES, Le Haillan (FR); CENTRE NATIONAL DE LA RECHERCHE SCIENTIFIQUE, Paris (FR)

(72) Inventors: Julien Souquet-Grumey, Poitiers (FR); Hervé Plaisantin, Pessac (FR); Sabine Valange, Liguge (FR); Jean-Michel Tatibouet, Poitiers (FR); Jacques Thebault, Bordeaux (FR); Joël Barrault, Liguge (FR)

(73) Assignees: HERAKLES, Le Haillan (FR); CENTRE NATIONAL DE LA RECHERCHE SCIENTIFIQUE, Paris (FR)

(21) Appl. No.: 14/112,953

(22) PCT Filed: Apr. 16, 2012
(86) PCT No.: PCT/FR2012/050829

§ 371 Date: Mar. 19, 2014

(30) Foreign Application Priority Data
Apr. 19, 2011 (FR) 1153370

(51) Int. Cl. B01J 31/28; B01J 31/02

(52) U.S. Cl. CPC B01J 31/28; B01J 31/0225
USPC 502/150

(57) ABSTRACT

A process for preparing a monolithic catalysis element includes a fibrous support and a catalytic phase supported by the fibrous support and also the monolithic catalysis element. The process includes the steps of preparing a porous coherent structure based on refractory fibers; preparing a substrate including the porous coherent structure and nanocarbon supported by the porous coherent structure in the body thereof; and grafting to the substrate, by π interaction, of at least one aromatic compound containing in its chemical formula, at least one aromatic ring, and at least one function chosen from acid catalytic functions, basic catalytic functions, metallic precursor functions, functions that can be converted in situ into metallic precursor functions, and mixtures thereof.

The present invention lies in the field of heterogeneous catalysis. The subject thereof is more precisely:
a process for preparing a (coherent) monolithic catalysis element comprising a fibrous support and a catalytic phase supported by said fibrous support; and
such a (coherent) monolithic catalysis element, which can be obtained by means of said process.

In this field of heterogeneous catalysis, dispersed catalysis elements have already been described and used, such as:
active carbons, with or without supported catalyst at their surface;
refractory nanofibers or nanotubes, in particular carbon nanofibers, supporting metallic catalysts. In this respect, the teachings of patent applications WO 2005/009589 and WO 2009/097669 and of U.S. Pat. No. 6,346,136 can be taken into consideration.

The advantage of the supports in question, refractory supports, which may or may not be carbon-based, is obvious. They are in particular resistant to acidic, basic and polar media. However, the dispersed, or even pulverulent, form of these catalysis elements poses problems, both in terms of the handling and use thereof and in terms of the recovery thereof (separation from the reaction medium).

Patent application WO 2003/048039 describes the application in catalysis of materials: C (carbon, in the form of beads, felts, extrusions, foams, monoliths, pellets, etc.)/CNFs or CNTs (carbon nanofibers or carbon nanotubes, formed by vapor deposition). The catalysts deposited on the materials are metallic catalysts, in particular based on noble metals. They are deposited in three steps: a) impregnation of the material (previously surface-functionalized by oxidation treatment) with a metal salt, b) calcination of the impregnated material for conversion of the salt to oxide, and c) reduction of said oxide to metal.

Patent application WO 2004/025003 describes the enrichment of three-dimensional fibrous structures of refractory fibers with carbon nanotubes (generated in situ by growth on said refractory fibers). Such enriched three-dimensional fibrous structures constitute preforms which are particularly advantageous for preparing thermostructural composite materials.

Patent application FR 2 892 644 describes a packing macrostructure for a fluidic exchange column, based on a plurality of rows of tube bundles. According to one embodiment variant, the plurality of tubes made of carbon or ceramic composite material can be densified, stiffened, by deposition of carbon therein (by chemical vapor deposition (CVD)). According to another embodiment variant, the surface of tubes made of carbon composite material of such a structure can be made hydrophilic by oxidation, and it is then possible to secure a catalyst to said surface by means of a conventional method comprising the successive steps of impregnating with a solution containing the catalyst and drying. Such a document describes neither enrichment of the macrostructure with nanocarbon, nor provision of catalyst via an organic compound.

The noncovalent functionalization of graphene and carbon nanofibers by adsorption of aromatic molecules via interactions between the cloud of delocalized π electrons of the graphene and carbon nanofibers and the π electrons of the aromatic molecules absorbed has also been described.

In such a context, the inventors provide a process for preparing a (coherent) monolithic catalysis element comprising a fibrous support and a catalytic phase supported by said fibrous support (which preparation process (for preparing a heterogeneous catalyst) constitutes the first subject of the invention presently claimed); said organic and/or inorganic catalytic phase being homogeneously dispersed within said fibrous support and, when it contains at least one metallic element, containing it in the form of nanoparticles, having a particle size with a low standard deviation. This result, with regard to the homogeneous dispersion of the organic and/or inorganic catalytic phase, in the body of the support, and to the size of the metallic particles, when they are present, is obtained in a completely original manner: by using an aromatic compound as dispersing agent, via the involvement of π interactions. This is explained later in the present text. The monolithic catalysis element thus prepared is effective, robust, stable and capable of existing according to numerous variants. It constitutes the second subject of the present invention.

According to a first subject, the present invention therefore relates to a process for preparing a monolithic catalysis element comprising a fibrous support and a catalytic phase supported by said fibrous support.

Characteristically, said process comprises:
the preparation of a porous coherent structure based on refractory fibers;
the preparation of a substrate comprising said porous coherent structure and nanocarbon supported by said porous coherent structure in the body thereof;
the grafting to said substrate, by π interaction, of at least one aromatic compound containing in its chemical formula, on the one hand, at least one aromatic ring, advantageously at least two, very advantageously four, aromatic rings and, on the other hand, at least one function chosen from acid catalytic functions, basic catalytic functions, metallic precursor functions, functions that can be converted in situ into metallic precursor functions, and mixtures thereof.

The fibrous support of the catalysis element prepared according to the invention is therefore a porous coherent structure based on refractory fibers, which is enriched in nanocarbon; it consists more precisely of a substrate comprising a porous coherent structure based on refractory fibers and nanocarbon (generally of a substrate consisting essentially of, or even exclusively of, a porous coherent structure based on refractory fibers and nanocarbon), said nanocarbon being supported by said porous coherent structure in the body thereof (said nanocarbon being secured to said porous coherent structure). Said structure is coherent in that it is capable of retaining its cohesion (its structural integrity) and its shape during manipulations. It is advantageously self-supporting.

For the introduction and stabilization of the catalytic phase within said fibrous support, at least one aromatic compound (aromatic compound comprising one ring or several rings) is, characteristically, grafted, by π interaction, to said substrate (by π interaction between the cloud of delocalized π electrons of the nanocarbon and the π electrons of the aromatic compound placed in the presence of said nanocarbon). The grafting is generally obtained by adsorption in a solvent medium.

Said at least one aromatic compound carries at least one catalytic function and/or at least one metallic precursor function and/or at least one function that can be converted (after grafting within the nanocarbon-enriched fibrous structure) into such a metallic precursor function (in fact a function which is itself a precursor of a metallic precursor function). It can be referred to as acid and/or basic aromatic in the event that said at least one aromatic compound contains at least one acid catalytic function and/or at least one basic catalytic function and salt of {(poly)aromatic-Me^{x+}} type or precursor of such a salt in the event that it contains, respectively, (at least) one metallic (metal) precursor function or one function that can be converted in situ into such a metallic precursor function. It has been understood that all the mixed variants are possible.

Such a metallic precursor function is a function which is a precursor of an active catalytic function, based on the action of a metal (in metal or metal oxide form). It is in fact a precursor of a metal, of particles of a metal. The metal in question may or may not consist of a noble metal. It is advantageously chosen from nickel, cobalt, iron, copper, manganese, gold, silver, platinum, palladium, iridium and rhodium. This list is not exhaustive. It should be noted incidentally here that different metallic precursor functions are entirely capable of being grafted, in the context of the process of the invention, to the same support.

Such a function that can be converted into a metallic precursor function is, for example, an acid function (—COOH) or a ligand function (—COOX function, X being a cation which can be exchanged with a metal, for example an alkaline metal or an alkaline-earth metal salt cation). Such a convertible function is generally bonded to an aromatic ring via a hydrocarbon-based chain.

The grafting of at least one aromatic compound with a metallic precursor function or functions (generally with a metallic precursor function) can therefore be direct grafting of the pre-existing aromatic compound in question (such a compound with a (for example) metallic precursor function was in particular able to be obtained prior to said grafting, ex situ, from the corresponding aromatic compound carrying a ligand function reacted with a metallic precursor. The reaction (ion exchange): sodium pyrene butanoate+cobalt chloride (CoCl₂.2H₂O) generates, for example, an aromatic compound (complex) comprising four aromatic rings with a metallic (Co) precursor function suitable for grafting by π interaction within the meaning of the invention) or (“indirect”) grafting of a first aromatic compound, followed by in situ conversion of said grafted aromatic compound. Such two-step grafting comprises:
a) the grafting of at least one aromatic compound containing in its chemical formula at least one function that can be converted into a metallic precursor function; followed by
b) the conversion, in situ, at least in part, of said at least one function that can be converted into at least one metallic precursor function.

The grafting can thus be carried out with at least one aromatic compound containing at least one acid function. In situ, said at least one acid function, by reaction with a metallic precursor, is directly converted into a metallic precursor function or it is first of all converted into a ligand function and then said ligand function is reacted with a metallic precursor so as to obtain the metallic precursor function. According to another variant, said at least one acid function of the aromatic compound is converted into a ligand function, before grafting (ex situ). After the grafting, in situ, said ligand function is reacted with a metallic precursor (thus, it is possible, for example according to this variant, a) to graft the sodium pyrene butanoate by π interaction, and then b) to react the cobalt chloride on the grafted sodium pyrene butanoate so as to generate in situ (by ion exchange) the metallic precursor function).

The obtaining of the active catalytic phase within the substrate can therefore take place, according to different implementation variants:
in a single step: grafting of at least one aromatic compound with a catalytic function or catalytic functions; and/or
in two steps: grafting of at least one aromatic compound with a metallic precursor function or metallic precursor functions and appropriate treatment for the conversion of said at least one metallic precursor function into at least one catalytically active metallic function (see hereinafter); and/or
in at least three steps: grafting of at least one aromatic compound with at least one function that can be converted into a metallic precursor function, conversion (in one or more steps), in situ, and at least in part, of said at least one function that can be converted into at least one metal precursor function and appropriate treatment for the conversion of said at least one metallic precursor function into at least one catalytically active metallic function (see hereinafter).

It is understood that the term “aromatic compounds” is intended to mean, conventionally, compounds which contain in their formula one aromatic ring (benzene compounds) and compounds which contain in their formula at least two aromatic rings, which are advantageously placed side by side (for example, naphthene compounds, anthracene compounds, pyrene compounds, etc.). The aromatic compounds in question advantageously contain in their formula at least two aromatic rings, very advantageously four aromatic rings.

The at least one aromatic compound grafted to the substrate is preferably of pyrene type.

The starting (fibrous) porous coherent structure can be a two- or three-dimensional (2D or 3D) structure.

A two-dimensional (2D) structure always has a certain thickness such that the nanocarbon can be stably secured in its body. Such a two-dimensional structure can in particular consist of a fabric.

Advantageously, the starting porous coherent structure is a self-supporting three-dimensional (3D) structure. Very advantageously, it consists of a flat 3D structure, as in particular described in patent application FR 2 584 106, or of a rotational 3D structure as in particular described in patent application FR 2 557 550 or patent application FR 2 584 107 or alternatively patent application FR 2 892 644.

According to embodiment variants, said porous coherent structure is a needled fibrous structure or a fibrous structure consolidated by a matrix. The needling of fibrous structures and the consolidation of fibrous structures by a matrix are techniques familiar to those skilled in the art. Such a consolidation comprises the deposition, in a fibrous structure, of a constituent material of a matrix. To obtain a porous coherent structure within the meaning of the invention, said material is deposited in an amount sufficient to confer on the fibrous structure its cohesion (i.e. sufficient for said fibrous structure to be sufficiently rigid to retain its structural integrity and its shape during manipulations), but not excessive so that the consolidated fibrous structure has an accessible porosity throughout the body thereof. The constituent material of the consolidation matrix can in particular consist of resin coke or of pyrocarbon.

According to preferred embodiment variants, the porous coherent structure may consist:
of a needled fibrous structure (of a stack of needled fibrous layers), or
of a plurality of tubes, each of said tubes being made of refractory fibers (for example, of carbon fibers) consolidated by a matrix (of pyrocarbon, for example); said tubes being arranged in four directions (such a structure is suitable in particular for forming a packing structure for a fluid exchange column, as described in application FR 2 892 644).

The obtaining of a porous coherent structure based on refractory fibers, in particular of such a 2D or 3D structure, more particularly of such a 3D structure of one of the types above, does not pose any particular difficulties to those skilled in the art (see, in particular, the teaching of the FR applications identified above).

As regards the preparation of the substrate, it is advantageously carried out, according to either of the variants below, also familiar to those skilled in the art:
by growth of the nanocarbon within the porous coherent structure based on refractory fibers, in situ growth by CVI (chemical vapor infiltration) (the different variants of the process described in application WO 2004/025003 can in particular be implemented); or
by introduction of pre-existing nanocarbon (generally of a suspension of nanocarbon in a liquid) into the porous coherent structure based on refractory fibers and securing of said nanocarbon to said refractory fibers via a resin coke (the nanocarbon has generally been introduced coated with resin and the coke resulting from the pyrolysis of said resin secures said nanocarbon to the fibers) or via a pyrocarbon film generated in situ by CVI.

Either of these variants enables the stable securing of nanocarbon to the refractory fibers, which securing is stable at the core of the porous coherent structure.

The nanocarbon is generally present in the form of nanotubes (CNTs, “nanotube”) and/or nanofibers (CNFs, “herringbone”), as in particular described in the publication by S.-H. Yoon et al., Carbon 43 (2005) 1828-1838, (see more particularly FIG. 8, page 1836, of said publication). It is more generally present in the form of nanotubes or of nanofibers. It is advantageously present in the form of nanofibers. This is because, on the one hand, it is easier to obtain nanofibers than nanotubes, in particular by growth of nanocarbon in situ, and on the other hand, nanofibers offer graphene planes which are more accessible for the grafting of aromatic molecules by π interaction. Those skilled in the art have understood that said aromatic molecules grafted by π interaction are more specifically grafted to the surface of nanotubes by π-π interaction and to the plane edges of nanofibers by π-σ interaction, as is described in the publication by E. R. Vorpagel et al., Carbon, Vol. 30, N°7, pages 1033-1040, 1992.

It is to the inventors' credit to have thought of π interactions of this type for obtaining a catalytic phase, which may or may not be of aromatic nature (see below), perfectly dispersed in a substrate of the type specified above (substrate comprising a porous coherent structure and nanocarbon supported by said porous coherent structure in the body thereof).

Within the porous coherent structure based on refractory fibers, the nanocarbon is generally present in a proportion, by weight, of from 2% to 200% of the weight of said fibrous structure.

As regards the nature of the refractory fibers, they are generally carbon fibers and/or ceramic fibers (for example, carbides such as SiC, oxides such as Al₂O₃, SiO₂, aluminosilicates (for example, Nextel®610 from the company 3M)). The porous coherent structure is in fact advantageously a structure based on carbon fibers or on ceramic fibers. It is very advantageously a structure based on carbon fibers (it is then possible to have a 100% carbon-based substrate). The grafting by π interaction of the process of the invention is thus advantageously carried out on a substrate of type: porous coherent structure based on fibres of carbon and nanocarbon (C/NC), very advantageously carried out on a substrate of type: porous coherent structure based on carbon fibers/C nanofibers (C/CNF) (see above).

At the end of the implementation of the grafting, the aromatic compound introduced is found mainly grafted to the nanocarbon of the substrate (given the large specific surface areas in question and, in addition, in the case of nanofibers, the plane edges present).

The intention is now to specify somewhat, in a manner that is in no way limiting, the nature of the aromatic compound containing in its chemical formula:
on the one hand, at least one aromatic ring, advantageously at least two aromatic rings, very advantageously four aromatic rings; and
on the other hand, at least one function chosen from acid catalytic functions, basic catalytic functions, metallic precursor functions, functions that can be converted in situ into metallic precursor functions, and mixtures thereof.

Said compound (catalyst per se or catalyst precursor) advantageously consists, as already indicated above, of a compound of pyrene type.

Said compound can therefore contain in its formula at least one acid catalytic function. Said function is advantageously chosen form carboxylic, sulfonic and boronic functions. Said compound can thus contain, in its formula, for example, one or more carboxylic functions, a carboxylic function and a sulfonic function, or a single sulfonic function. All situations can be envisioned. According to one preferred variant, the at least one aromatic compound comprising an acid catalytic function consists of 1-pyrenesulfonic acid or of 1-pyrenebutyric acid.

Said compound can therefore contain in its formula at least one basic catalytic function. Said function is advantageously chosen from linear or branched amine functions, functions of guanidine type and functions of phosphazene type.

Said compound can therefore contain in its formula at least one metallic precursor function. It then generally consists of a salt of {(poly)aromatic-Me^{x+}} type, where Me represents a metal, advantageously chosen from nickel, cobalt, iron, copper, manganese, gold and silver. Said salt is generally a salt of an ester and of a metal (obtained by ion exchange from the corresponding salt of an ester and of an alkali or alkaline-earth metal (see the above example of sodium pyrene butanoate)). The metal in question, in oxide or metal form (see below), constitutes in the end the uniformly distributed, supported catalytic phase of the desired monolithic catalysis element.

Said compound can therefore contain in its formula at least one function that can be converted in situ into a metallic precursor function. It has been seen above that such a convertible function can in particular consist of an acid function (—COOH) or a ligand function (—COOX, X being a cation capable of being exchanged with a metal, for example an alkali metal or alkaline-earth metal salt cation).

It has been understood that several different aromatic compounds (each with at least one different catalytic, precursor or convertible function and/or with a different number and/or arrangement of aromatic rings) are capable of being grafted according to the invention mainly to the nanocarbon of the substrate, and that one and the same aromatic compound can contain several functions chosen from the four types of functions specified above, which may or may not be of the same type.

According to “elementary” implementation variants of the process of the invention, an aromatic compound which contains at least one (generally just one) acid or basic catalytic function, or an aromatic compound which contains at least one (generally just one) metallic precursor function (which is subsequently converted into an active catalytic function, based on the action of a metal (in the metal state or in the oxide state)) or an aromatic compound which contains at least one (generally just one) function that can be converted into at least one (generally one) metallic precursor function (which is subsequently converted successively into said at least one metallic precursor function and then into an active catalytic function, based on the action of a metal (in the metal state or in the oxide state)) is grafted to the substrate by π interaction. The following is thus obtained:
directly, the monolithic catalysis element desired, the catalytic phase of which is acid or basic; or
in at least two steps, the monolithic catalysis element desired, the catalytic phase of which is metallic (consisting of a metal or of an oxide).

Said acid, basic and/or metallic catalytic phase is uniformly distributed in the body of the substrate.

It is intended to specify hereinafter the variant of the process which results in the homogeneous distribution of a metallic catalytic phase (in the form of nanoparticles (having a particle size with a low standard deviation)) in the body of the substrate. It comprises:
the preparation of a porous coherent structure based on refractory fibers (see above);
the preparation of a substrate comprising said porous coherent structure and nanocarbon supported by said porous coherent structure in the body thereof (see above); and
the grafting, directly or via that of at least one aromatic compound containing in its chemical formula at least one function that can be converted in situ into at least one metallic precursor function (indirect grafting), of at least one aromatic compound containing in its chemical formula at least one metallic precursor function, the metal in question being advantageously chosen from Ni, Co, Fe, Cu, Mn, Au and Ag (see above).

It further comprises, as also already indicated above, the treatment of the substrate grafted with said at least one aromatic compound containing in its chemical formula at least one metallic precursor function, for the purpose of converting said at least one metallic precursor function into a catalytically active (metallic) function.

The treatment can consist of heat activation. Such heat activation generates particles based on the metal (metals) corresponding to said at least one metallic precursor, mainly particles of oxide of said metal (of said metals). Such heat activation may or may not, depending on the temperature at which it is carried out, result in thermal decomposition of the aromatic compound present. It generally results in at least partial decomposition of said compound. It may be assumed that said at least one partially decomposed aromatic compound acts as an adhesive for the in situ-generated particles based on the metal(s). Thus, migration of the metallic catalytic phase, uniformly dispersed owing to the original grafting of the process of the invention, is prevented, as is by the same token the enlargement of said in situ-generated particles. The resulting inorganic catalytic phase is very well distributed within the porous coherent structure based on refractory fibers, in the form of nanoparticles (having a particle size distribution with a low standard deviation). In order to limit the thermal decomposition of the at least one aromatic compound present, it is recommended that the heat activation be carried out below 640° C. It is generally carried out between 350 and 640° C. Following such heat activation, a reduction under hydrogen can be carried out: the oxide particles are then reduced to metal particles. The dispersions and sizes (sizes per se and distributions of said sizes) of said metal particles are, in the same way, particularly advantageous.

The treatment may advantageously consist of a reduction under hydrogen. Such a reduction under hydrogen generates particles based on the metal (metals) corresponding to said at least one metallic precursor, mainly particles of said metal (of said metals). The fate of the aromatic compound(s) which served, as indicated above, as catalytic phase dispersing agent is linked to the temperature at which said reduction under hydrogen is carried out. Advantageously, said reduction under hydrogen is carried out under mild conditions (at a temperature of at most 500° C., generally between 350 and 500° C. such that the aromatic compound(s) introduced is (are) preserved (virtually) intact. In this event, the uniformly distributed catalytic phase also does not have the ability to migrate and to become larger (the distribution of the sizes of the nanoparticles obtained is very narrow). It should be noted incidentally that, generally, such a reduction is carried out under conditions that are milder than the oxidation described above.

In the context of the implementation of the process of the invention for obtaining a monolithic catalysis element with a catalytic phase containing at least one metal, the treatment for conversion of the at least one metallic precursor function into a catalytically active function is advantageously carried out at a temperature at which the at least one aromatic compound is only partially pyrolyzed or is not pyrolyzed.

The process of the invention, as described above, makes it possible in particular to obtain (coherent) monolithic catalysis elements:
with an acid and/or basic catalytic phase,
with a metallic catalytic phase, and
with a “mixed” (or more exactly multifunctional) catalytic phase: acid and/or basic and metallic, assuming that aromatic compounds with catalytic functions and metallic precursor functions (same compounds or different compounds) have been grafted and that at least some of said catalytic functions have withstood the conditions for conversion of the metallic precursor functions (a reduction can be carried out under mild conditions). It is also possible to envision two successive implementations of the process of the invention: the first for the introduction of a metallic catalytic phase and the second for the introduction of an acid and/or basic catalytic phase.

To obtain monolithic catalysis elements with a “mixed” (or more exactly multifunctional) catalytic phase, the following can also be carried out:
depositing (at least) one metallic precursor within the substrate (generally by impregnation with a solution containing a salt) and converting said metallic precursor(s) into metallic element(s) (by heat activation and/or reduction under H₂) for the generation in situ of a metallic catalytic phase (within said substrate); or depositing (directly) a metallic catalytic phase (within said substrate) by chemical vapor deposition (CVD) or plasma deposition,
grafting to said substrate, by π interaction, at least one aromatic compound containing in its chemical formula, on the one hand, at least one aromatic ring, advantageously at least two, very advantageously four, aromatic rings and, on the other hand, at least one function chosen from acid catalytic functions, basic catalytic functions and mixtures thereof.

For the introduction of the metal (in metal or oxide form), the procedure is therefore initially carried out conventionally and then is carried out according to the invention for the introduction of an acid and/or basic catalytic function or functions. It should be noted that it is possible to invert the steps, i.e. to first proceed according to the invention and then subsequently conventionally, but that the disappearance of the functional aromatic compound grafted during the in situ generation of the metal is then to be feared. It is highly recommended in this context to generate the metal by reduction, carried out under mild conditions. Heat activation is virtually excluded.

Those skilled in the art are able to optimize the protocol, case by case.

It emerges from the description above that the process of the invention can be carried out according to multiple variants so as to ensure homogeneous distribution within a specific substrate—said substrate comprising the porous coherent structure based on refractory fibers and nanocarbon supported by said porous coherent structure in the body thereof, in particular substrate of type: refractory fibers/NC (nanocarbon) and more particularly substrate of type: C fibers/NC (nanocarbon), C fibers/CNFs (carbon nanofibers)—of numerous types of catalysts: organic and/or inorganic.

The monolithic catalysis elements which can be obtained by means of the process of the invention as described above (by means of one or other of its numerous variants) constitute the second subject of the present invention.

Their original structure therefore comprises, on the one hand, the fibrous support—substrate comprising the porous coherent structure and nanocarbon supported by said porous coherent structure in the body thereof (fibrous structure based on refractory fibers which is enriched in nanocarbon)—and, on the other hand, secured to said fibrous support, an original catalytic phase.

According to a first variant, the catalytic phase present is organic. It contains at least one aromatic compound containing in its chemical formula, on the one hand, at least one aromatic ring, advantageously at least two, very advantageously four, aromatic rings and, on the other hand, at least one function chosen from acid catalytic functions and basic catalytic functions; said at least one aromatic compound being bonded, by π interaction, to the fibrous support. It has been seen above that said at least one aromatic compound is essentially bonded, by π interaction, to the nanocarbon of said fibrous support.

It may be indicated here, in a manner that is in no way limiting, that monolithic catalysis elements of the invention, with an organic catalytic phase, may opportunely be used for carrying out a chemical reaction chosen from:
the Michaël reaction,
the Knoevenagel reaction,
etherification, esterification, transesterification reactions,
selective hydrogenation reactions,
Fischer-Tropsch reactions, and
controlled oxidation reactions.

According to a second variant, the catalytic phase present is inorganic. It contains nanoparticles of metal oxide and/or of metal (the metal in question being advantageously chosen from nickel, cobalt, iron, copper, manganese, gold, silver, platinum, palladium, iridium and rhodium), which are secured to the fibrous support (mainly to the nanocarbon of said fibrous support) via at least one aromatic compound which is not pyrolyzed, is partially pyrolyzed or is virtually totally pyrolyzed (advantageously not pyrolyzed or only partially pyrolyzed). The nanoparticles in question have a size (an average diameter) of only a few nanometers (generally from 0.1 to 10 nm, more generally from 1 to 5 nm). The process of the invention for obtaining this inorganic catalytic phase has left several signatures: the small size of the particles and the particle size distribution with a low standard deviation of said particles, the homogeneous dispersion of said particles in the fibrous structure and the more or less visible presence of the at least one aromatic compound.

The monolithic catalysis elements of the invention, with an inorganic catalytic phase, can most certainly be opportunely used for carrying out many chemical reactions known to be catalyzed by one metal and/or another.

According to a third variant, the catalytic phase is mixed. It consists partly of an organic catalytic phase as specified above (“organic catalytic phase of the invention”) and partly of an inorganic catalytic phase, which may be an inorganic catalytic phase “according to the invention” (obtained via at least one organic compound) and/or an inorganic catalytic phase of the prior art (see above).

It is emphasized here that the catalytic phase(s) obtained by means of the process of the invention—via the grafting by π interaction—is (are) uniformly distributed within the substrate (very predominantly on the nanocarbon of said substrate).

All the information given above in the description of the process regarding the various terms used (in particular, porous coherent structure, nanocarbon, aromatic compound, catalytic function, metallic precursor function, etc.) can be reiterated here to specify the monolithic catalysis elements of the invention.

The invention is now illustrated, in a manner that is in no way limiting, by the examples and figures hereinafter.

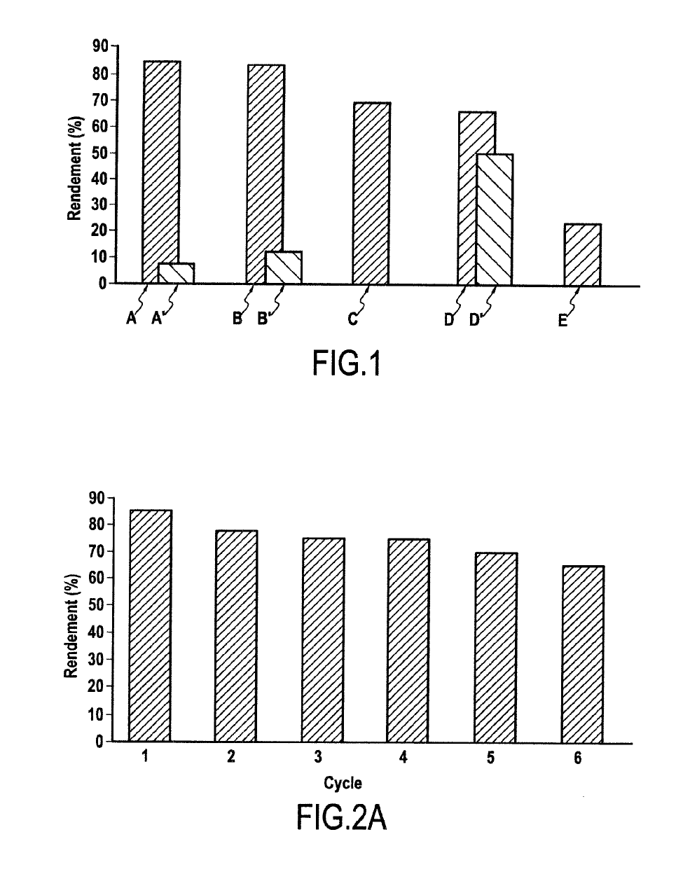

FIG. 1 shows the yields obtained, after 2 h of reaction, for a Michael reaction, carried out in the presence of various catalytic elements, including the catalytic elements A, B and C of the invention (see example A III.2 hereinafter).

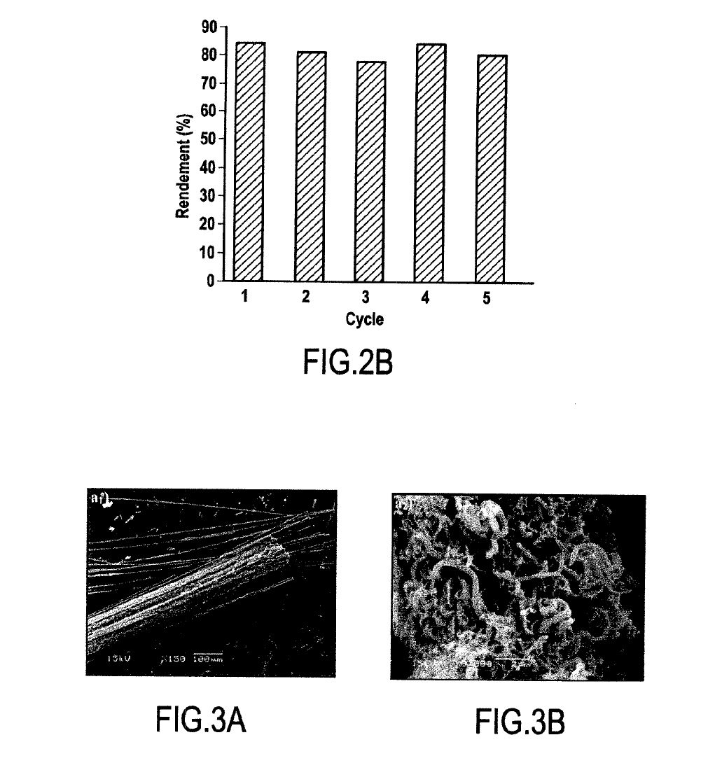

FIGS. 2A and 2B show the yields obtained under the same conditions (for, respectively, the catalytic elements A and B of the invention) after n cycles of use (see example A III.3 hereinafter).

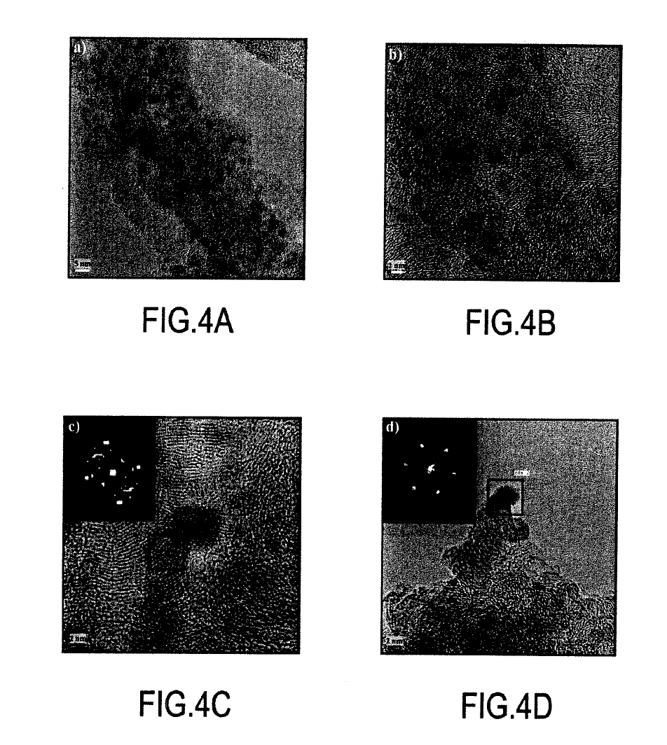

FIGS. 3A and 3B are scanning electron microscopy (SEM) images at various magnifications, FIGS. 4A and 4D are transmission electron microscopy (TEM) images at various magnifications, of catalysis elements of the invention comprising an inorganic supported catalytic phase; said inorganic supported catalytic phase having been obtained, characteristically, via the grafting of an organic compound (see example B III. hereinafter).

### EXAMPLE A

### I. Components of Catalysis Elements of the Invention

1) Fibrous Supports (Crude=without Active Catalytic Phase)

The fibrous supports used are based on carbon fibers, in the form of 2D fabrics or arranged as a body in the form of self-supporting 3D structures (according to application FR 2 892 644, application FR 2 584 106 or application FR 2 584 107), obtained by pyrolysis of rayon fibers (ex-RAY support) or of polyacrylonitrile fibers (ex-PAN support).

Said fibrous supports were enriched to the core with carbon (type nanofiber: CNF) (the growth of the nanocarbon was carried out by CVI (atmospheric pressure, temperature of 700° C., duration of 30 min, in the presence of Ni (catalyst), using a hydrogen/ethylene mixture)).

The carbon nanofibers are present in a proportion of approximately 7%, 30% or 20% by weight (CNF/C+CNF) in the fibrous supports used. The following were more precisely used:
an ex-RAY support containing 7.4% by weight of carbon nanofibers (substrate C/CNF: A′)
an ex-PAN support containing 30% by weight of carbon nanofibers (substrate C/CNF: B′), and
an ex-PAN support containing 21.9% by weight of carbon nanofibers (substrate C/CNF: C′).

### 2) Active Catalytic Phase

The aromatic compound in question is 1-pyrenesulfonic acid, of formula:

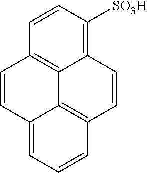 [SMILES: O=S(=O)(O)c1ccc2ccc3cccc4ccc1c2c34]

The catalysis elements of the invention, prepared as specified hereinafter, are referenced:
Substrate C/CNF with catalyst: A (the aromatic compound above (cata.) is bonded, at a level of 10% (by weight), to the ex-RAY support with 7.4% by weight of carbon nanofibers);
Substrate C/CNF with catalyst: B (the aromatic compound above (cata.) is bonded, at a level of 10% (by mass), to the ex-PAN support with 30% by weight of carbon nanofibers);
Substrate C/CNF with catalyst: C (the aromatic compound above (cata.) is bonded, at a level of 10% (by mass), to the ex-PAN support with 21.9% by weight of carbon nanofibers).

### II. Preparation of Catalysis Elements of the Invention (A, B and C)

The crude fibrous supports (A′, B′, C′) (1 g) and the 1-pyrenesulfonic acid (100 mg, 10% (wt)) were dispersed in ethanol (100 ml). The suspension obtained was stirred for 30 min at ambient temperature using an ultrasonic bath (<40 W). The solvent (ethanol) was then evaporated off using a rotary evaporator (45° C. under vacuum).

Reference catalysis elements (D and E) of sulfonated carbon and sulfonated silica type were also prepared, using respectively:
a) Vulcan XC 72 carbon (said crude carbon constitutes the reference D′), treated with hot concentrated sulfuric acid for 4 h. The catalyst is then washed (water then ethanol) and oven-dried to give the Vulcan XC 72-SO₃H catalyst. The final concentration of —SO₃H group is 0.8 mmol g⁻¹,
b) a mesoporous silica with hexagonal pores (HMS), treated with H₂O₂ (35% (wt)) at ambient temperature for 24 h. The catalyst is washed (water then ethanol) and oven-dried. The solid is then stirred in a solution of H₂SO₄ (0.1 M) for 4 h and then again washed (water then ethanol) and oven-dried to give the SiO₂ (HMS)-SO₃H catalyst. The final concentration of —SO₃H group is 0.8 mmol g⁻¹.

### III. Tests

1) The catalysis elements of the invention (and the reference catalysis elements) were tested in a reaction for creating carbon-carbon bonds: the Michael reaction between indole and trans-β-nitrostyrene.

Said reaction, represented schematically below:

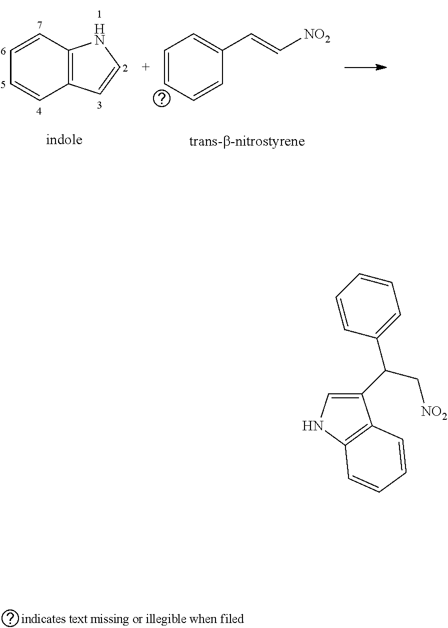 [SMILES: c1ccc2[nH]ccc2c1 ; O=[N+]([O-])/C=C/c1ccccc1 ; O=[N+]([O-])CC(c1ccccc1)c1c[nH]c2ccccc12]

was carried out in heptane at 90° C., in the presence of 5 mol % of catalysis elements:
substrate C/CNF with and without catalyst: A and A′,
substrate C/CNF with and without catalyst: B and B′,
substrate C/CNF with catalyst: C,
Vulcan XC 72-SO₃H or crude: D and D′, and also
SiO₂ (HMS)-SO₃H:E.

Said reaction generates the compound of which the formula is given above. It is presently 3-(1-phenyl-2-nitroethyl)-1H-indole. The Michael reaction makes it possible more generally to prepare indole derivatives which are alkylated in the 3 position (according to the reaction scheme above). Said derivatives are of interest in the pharmaceutical field.

2) After two hours of reaction, the following results (yields) were obtained:
7.5% with the substrate A′,
85% with the substrate A,
12% with the substrate B′,
84% with the substrate B,
70% with the substrate C,
66% with Vulcan XC 72-SO₃H (D),
50% with Vulcan XC 72 (D′), and
23% with SiO₂ (HMS)-SO₃H (E).

Said results appear in the appended FIG. 1.

The advantage of the catalysis elements of the invention is thus clearly demonstrated.

3) The stability of catalysis elements of the invention was, moreover, verified by recycling said elements up to six times (in the context of carrying out the Michael reaction above).

The elements A and B of the invention were thus tested.

The results obtained are satisfactory.

They are shown in the appended FIGS. 2A and 2B, for respectively therefore the catalysis elements of the invention A and B.

It is incidentally noted that the substrate B shows better stability than the substrate A.

The inventors tested, under the same conditions, the stability of the aromatic compound (1-pyrenesulfonic acid) per se (the 83% yield in the first cycle drops to 35% in the second cycle) and that of a catalysis element consisting of said aromatic compound attached (under the conditions indicated above for obtaining the catalysis elements of the invention) to the Vulcan XC 72 carbon (the 75% yield in the first cycle is 68% in the second cycle and then 53% in the third cycle).

The results (shown and not shown in the figures) therefore clearly favor the catalysis elements of the invention A and B.

### EXAMPLE B

### I. Component and Precursor of Component of Catalysis Elements of the Invention

1) Fibrous Support (Crude=without Active Catalytic Phase)

An ex-Ray support enriched in nanofibers: C/CNF (with a very high pore volume: approximately 0.05 cm³ g⁻¹, determined by nitrogen adsorption) was used.

2) Cobalt Complex (Precursor of the Active Catalytic Phase Prepared Ex-Situ)

Pyrenebutyric acid (100 mg, 3.5×10⁻⁴ mmol) is suspended in distilled water (50 ml), and then a solution of NaOH at 0.05 mol l⁻¹ (7 ml, 3.5×10⁻⁴ mmol) is added dropwise so as to form sodium pyrene butanoate. CoCl₂.2H₂O (57.7 mg, 3.5×10⁻⁴ mmol), dissolved in water, is added dropwise. A pinkish precipitate forms. The suspension is stirred for 30 min at ambient temperature, and then centrifuged (3500 rpm, 10 min) in order to remove the supernatant. The pinkish solid is washed with distilled water (25 ml), and then with acetone (25 ml). The washing step makes it possible to remove the residual cobalt chloride and the residual pyrenebutyric acid and also the salts formed (NaCl) during the complexation. The solid (aromatic compound (of pyrene type) within the meaning of the invention, the formula of which contains four aromatic rings and a metallic precursor function) is oven-dried at 70° C. for 2 h, and then at 90° C. for 12 h.

### II. Preparation of a Catalysis Element of the Invention

The fibrous support, substrate C/CNF (50 mg), is impregnated with the cobalt complex (10 mg, 1.8% by weight of Co) dissolved in a minimum of THF (volume<1 ml).

Said impregnated fibrous support is then oven-dried for 12 h.

Finally, it is heat activated at 300° C. (ramp of 5° C. min⁻¹, isotherm 1 h at 300° C.). Particles of cobalt oxide are thus generated in situ. The aromatic compound, at this temperature of 300° C., is not pyrolyzed.

### III. Analysis of the Catalysis Element of the Invention

The analysis of the catalysis element thus prepared (catalyst: substrate C/CNF-cobalt-based particles) revealed a cobalt content of 1.2% by weight (for therefore a starting amount of impregnation of 1.8% by weight).

Scanning electron microscopy images, at various magnifications, of said catalysis element are shown in FIGS. 3A and 3B. In FIG. 3A, the carbon fibers of the fibrous structure are clearly seen. In FIG. 3B, at higher magnification, the surface of a fiber enriched in carbon nanofibers is seen.

Transmission electron microscopy images were also taken in order to observe the cobalt (˜cobalt oxide)-based particles (see FIGS. 4A to 4D). These images show nanoparticles (black spots on the nanofiber portion shown in FIGS. 4A and 4B) containing cobalt (this is confirmed by EDX) at the surface of the carbon nanofibers. The digital diffractograms of these nanoparticles (corresponding to the zones represented on the images of FIGS. 4C and 4D), confirm the presence of cubic Co₃O₄. These cobalt oxide nanoparticles are homogeneously distributed at the surface of the carbon nanofibers and have sizes of between 1 and 4 nm.

This cobalt complex impregnation method therefore proves to be very effective in that it makes it possible in particular to control the distribution and the size of the cobalt oxide particles. It advantageously replaces the conventional treatments of C/C substrates or carbon nanotubes requiring a preliminary step of oxidation with acids: said conventional treatments generate larger particles.

Those skilled in the art have certainly understood the advantage of these nanoparticles, which are uniformly distributed and of uniform sizes, in catalysis.

### EXAMPLE C

### I. Components of Catalysis Elements of the Invention

1) Fibrous Supports (Crude=without Active Catalytic Phase)

Various fibrous supports were used, in particular the support B′ (substrate C/CNF) of example A I. 1) above: ex-PAN support containing 30% by mass of carbon nanofibers.

2) Active Catalytic Phase
The following aromatic compounds were used:

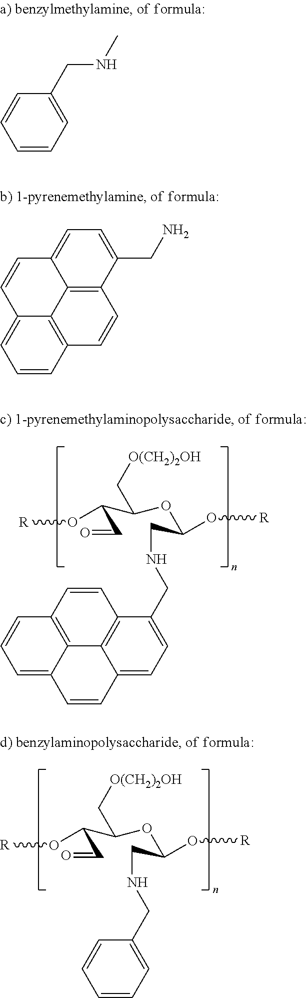

### II. Preparation of Catalysis Elements of the Invention

These aromatic compounds a) to d) were deposited on the various fibrous supports, including the support B′, according to a procedure (adsorption-deposition) identical to that specified in example A II. above.

Said compounds were deposited at levels (concentration of active phase of the catalysis elements obtained) between 5% and 15% (by weight).

### III. Tests

The catalysis elements thus prepared were tested, also in the Michael reaction.

Given the basic and amphiphilic nature of the organic compounds (active phases) in question, said organic compounds could in fact be expected to develop, like the acid catalysts (such as 1-pyrenesulfonic acid), a catalytic activity in this reaction. The Michael reaction between indole and trans-β-nitrostyrene (see example A III. 1) above) in fact requires catalytic activation of acid nature of the indole and/or catalytic activation of basic nature of the trans-β-nitrostyrene.

The yields of approximately 70% were obtained with the catalysis elements of the invention of the present example (bearing the active phases a), b), c) or d), of basic nature), under experimental conditions corresponding to those specified in example A III. 1).

More specifically, a yield of, respectively, 72% and 67%, was obtained with the catalysis elements of the invention of the present example, identified hereinafter: support B′ with 10% by weight, respectively, of the compound a) and of the compound d).

1-22. (canceled)

23. A process for preparing a monolithic catalysis element comprising a fibrous support and a catalytic phase supported by said fibrous support, wherein it comprises:
the preparation of a porous coherent structure based on refractory fibers;
the preparation of a substrate comprising said porous coherent structure and nanocarbon supported by said porous coherent structure in the body thereof; and
the grafting to said substrate, by π interaction, of at least one aromatic compound containing in its chemical formula, at least one aromatic ring and at least one function chosen from the group consisting of acid catalytic functions, basic catalytic functions, metallic precursor functions, functions that can be converted in situ into metallic precursor functions, and mixtures thereof.

24. The process as claimed in claim 23, further comprising said grafting of at least one aromatic compound containing in its chemical formula at least one function chosen from functions that can be converted in situ into metallic precursor functions and in that it further comprises the conversion, in situ, of said at least one function into at least one metallic precursor function.

25. The process as claimed in claim 23, wherein said porous coherent structure is a two- or three-dimensional structure.

26. The process as claimed in claim 23, wherein said porous coherent structure is a needled fibrous structure or a fibrous structure consolidated by a matrix.

27. The process as claimed in claim 23, wherein the preparation of said substrate comprises:
the growth of the nanocarbon within the porous coherent structure by CVI, or
the introduction of pre-existing nanocarbon into the porous coherent structure and the securing thereof to the refractory fibers of said fibrous coherent structure via a resin coke or via a pyrocarbon film generated in situ by CVI.

28. The process as claimed in claim 23, wherein said nanocarbon is present in the form of nanotubes or nanofibers.

29. The process as claimed in claim 23, wherein said nanocarbon represents, by weight, from 2% to 200% of the weight of said porous coherent structure.

30. The process as claimed in claim 23, wherein said refractory fibers are carbon fibers or ceramic fibers.

31. The process as claimed in claim 23, wherein said at least one aromatic compound is of pyrene type.

32. The process as claimed in claim 23, further comprising the grafting of at least one aromatic compound containing in its chemical formula at least one acid catalytic function.

33. The process as claimed in claim 32, wherein said at least one aromatic compound consists of 1-pyrenesulfonic acid or of 1-pyrenebutyric acid.

34. The process as claimed in claim 23, wherein it comprises the grafting of at least one aromatic compound containing in its chemical formula at least one basic catalytic function.

35. The process as claimed in claim 23, further comprising the grafting, directly or via that of at least one aromatic compound containing in its chemical formula at least one function chosen from functions that can be converted in situ into metallic precursor functions, of at least one aromatic compound containing in its chemical formula at least one metallic precursor function.

36. The process as claimed in claim 35, further comprising the treatment of the substrate grafted with said at least one aromatic compound containing in its chemical formula at least one metallic precursor function, for converting said at least one metallic precursor function into a catalytically active function.

37. The process as claimed in claim 36, wherein said treatment comprises heat activation arranged to generate particles based on the metal corresponding to said at least one metallic precursor substantially comprising particles of oxide of said metal.

38. The process as claimed in claim 37, wherein said treatment comprises, following said heat activation, a reduction under hydrogen arranged to generate particles based on the metal corresponding to said at least one metallic precursor substantially comprising particles of said metal.

39. The process as claimed in claim 36, wherein said treatment comprises a reduction under hydrogen arranged to generate particles based on the metal corresponding to said at least one metallic precursor substantially comprising particles of said metal.

40. The process as claimed in claim 36, wherein said treatment is carried out at a temperature at which said at least one aromatic compound containing in its chemical formula said at least one metallic precursor function is not pyrolyzed or is only partially pyrolyzed.

41. The process as claimed in claim 23, further comprising:
the deposition of at least one metallic precursor within the substrate and the generation in situ of a metallic catalytic phase within said substrate by conversion of said at least one metallic precursor, or the deposition of a metallic catalytic phase within said substrate by chemical vapor deposition or plasma deposition,
the grafting to said substrate, by π interaction, of at least one aromatic compound containing in its chemical formula at least one aromatic ring and at least one function selected from the group consisting of acid catalytic functions, basic catalytic functions and mixtures thereof.

42. A monolithic catalysis element comprising a fibrous support and a catalytic phase supported by said fibrous support obtained by means of the process as claimed in claim 23.

43. The monolithic catalysis element as claimed in claim 42, wherein said catalytic phase contains at least one aromatic compound containing in its chemical formula at least one aromatic ring and at least one function chosen from acid catalytic functions and basic catalytic functions; said at least one aromatic compound being bonded by π interaction, to said fibrous support.

44. The monolithic catalysis element as claimed in claim 42, wherein said catalytic phase contains nanoparticles of metal oxide and/or of metal, secured to said fibrous support via said at least one aromatic compound which is not pyrolyzed or only partially pyrolyzed or virtually totally pyrolyzed.

45. The process as claimed in claim 23, wherein said at least one aromatic compound contains in its chemical formula at least two aromatic rings.

46. The process as claimed in claim 23, wherein said at least one aromatic compound contains in its chemical formula at least four aromatic rings.

47. The process as claimed in claim 24, wherein said at least one aromatic compound contains in its chemical formula at least one acid function or at least one ligand function.

48. The process as claimed in claim 23, wherein said porous coherent structure is a three-dimensional structure.

49. The process as claimed in claim 23, wherein said porous coherent structure is a planar or rotational three-dimensional structure.

50. The process as claimed in claim 23, wherein said nanocarbon is present in the form of nanofibers.

51. The process as claimed in claim 23, wherein said refractory fibers are carbon fibers.

52. The process as claimed in claim 32, wherein said at least one acid catalytic function is selected from the group consisting carboxylic, sulfonic and boronic functions.

53. The process as claimed in claim 34, wherein said at least one basic catalytic function is selected from the group consisting of linear or branched amine functions, functions of guanidine type and functions of phosphazene type.

54. The process as claimed in claim 35, wherein the metal is selected from the group consisting of nickel, cobalt, iron, copper, manganese, gold, silver, platinum, palladium, iridium and rhodium.

55. The monolithic catalysis element as claimed in claim 43, wherein said at least one aromatic compound contains in its chemical formula at least two aromatic rings.

56. The monolithic catalysis element as claimed in claim 43, wherein said at least one aromatic compound contains in its chemical formula at least four aromatic rings.

57. The monolithic catalysis element as claimed in claim 44, wherein said catalytic phase contains nanoparticles of metal oxide and/or of metal secured to said fibrous support via said at least one aromatic compound which is not pyrolyzed or only partially pyrolyzed.
